(19) United States
(12) Patent Application Publication
(10) Pub. No.: US 2011/0248882 A1
(43) Pub. Date: Oct. 13, 2011

(54) METHOD FOR INTERFEROMETRIC RADAR MEASUREMENTS

(75) Inventors: Francesco Coppi, Calcinaia (IT); Alessandro Bertoneri, Massa (IT); Gaetano Di Pasquale, San Giuliano Terme (IT)

(73) Assignee: IDS INGEGNERIA DEI SISTEMI S.P.A., Pisa (IT)

(21) Appl. No.: 13/140,170

(22) PCT Filed: Dec. 31, 2009
(86) PCT No.: PCT/EP09/09344

§ 371 Date: Jun. 22, 2011

(30) Foreign Application Priority Data
Dec. 31, 2008 (IT) PI2008A000139

(51) Int. Cl. G01S 13/32; G01S 13/34

(52) U.S. Cl. 342/156

(57) ABSTRACT

A method for interferometric radar measurements that provides prearranging, at a target observed by the radar, of a transponder that is adapted to perform a frequency shift f_{d} of a radar signal received by the target, and to retransmit a response signal towards the radar. The frequency-shift is such that the signal (21), as received by the radar, can be separated from clutter (19) coming from the radar scenario, by a demodulation step (A), in particular a coherent demodulation step, and a phase extraction step (B), which may comprise a further demodulation step by a phasor that has a frequency equal to f_{d}. If these steps are carried out subsequently, it is possible to calculate the phase difference with respect to signals 22 and then measuring the displacement that target (2) carries out between such instants. In case of a plurality of targets in a same radar scenario, the use of a corresponding plurality of transponders with specific frequency-shifts allows separately demodulating the signals coming from each transponder. In case of variable frequency radar signals, in particular if the frequency is increased according to a predetermined pitch, i.e. a frequency step, the phase extracting step may provide sampling sequences of values of the response signal coming from respective resolution cells of the radar scenario, and applying the inverse discrete Fourier transform to such sequences, in order to display the target in a resolution cell that is located between a maximum distance available by the radar and the limit of range unambiguous. The method allows overcoming well-known prior art interferometric radar systems drawbacks, since it eliminates clutter, and allows resolving more target in a same radar scenario, or in a same resolution cell.

### FIELD OF THE INVENTION

The present invention relates to the field of radar detection, and more precisely it relates to a method for determining displacements of remote objects by means of an interferometric radar.

Interferometric radars are used for remote monitoring of phenomena characterized by slow displacements such as landslides, subsidence, and deformations of civil works such as buildings, bridges, off-shore structures, river banks, open pits, and the like.

### BACKGROUND OF THE INVENTION

Interferometric radars allow to detect remote objects displacements that occurs between a first and a second instant, by measuring the phase variation, between the two instants, of the electromagnetic signal reflected by the remote object, which is illuminated by a signal, i.e. an electromagnetic wave, emitted by the radar. The displacement d is related to the variation of the phase p of the reflected signal according to the following equation:

d=−(λ/4π)(φ₂−φ₁) [1]

where λ is the wavelength of the electromagnetic wave and φ₁, φ₂ are the phase of the return signals received by the radar at instants t₁ and t₂, respectively, before and after the displacement has occurred. The maximum displacement that can be detected by the radar between t1 and t2 is equal to one fourth of wavelength λ, with an accuracy that is responsive to the accuracy by which phase φ is measured, which depends upon radar system performances. A typical phase accuracy value is 1 degree; therefore, for instance, if an electromagnetic signal that has a wavelength of 18 mm is used, a displacements up to 4.5 mm can be measured, with an accuracy of about 0.1 mm.

Interferometric radar systems are referred to, for instance, in EP1983353. A first interferometric radar system is the CW (Continuous Wave) interferometric radar, in which a continuous sinusoidal signal is used. The main drawbacks of such a radar system are:

a) they are able to detect the displacement of a single target, i.e. of a single remote object, that is present in the radar scenario, i.e. the portion of space that can be seen by the radar, provided that the target can reflect the signal and produce a far stronger return signal with respect to any other reflecting objects that may be present in the radar scenario;
b) in any case, the return signal, as received by the radar, is affected by “clutter”, i.e. by a noise that is due to other objects that may be present in the radar scenario, which also reflect the emitted signal.

To cope with such problems, radar systems have been developed that allow to subdivide the scenario in a plurality of resolution cells that can be analysed independently from one another.

One of these systems, which are also referred to in the above-mentioned is EP application, is the SFCW (Stepped Frequency Continuous Wave) radar. SFCW radar systems provide iteratively transmitting a sequence of tones that are sequentially ordered in such a way that the frequency increases from the first to the last tone, according to a prefixed frequency pitch Δf. These systems allow to resolve the scenario in the range (radial) direction, i.e. they allow to distinguish targets that are placed at different distances from the radar. An improvement of this method combines SFCW technique with SAR/RAR (Synthetic/Real apertures Radar) techniques, and allows to resolve the scenario also in “cross range”, i.e. orthogonally to the range direction, such that smaller resolution cells are obtained than in the case of SFCW radar. The smaller the resolution cells, the less likely more targets fall in a same cell, and the fewer clutter sources are present in each cell; however, the aforementioned interferometric CW-radar drawbacks still apply within each resolution cell. Besides, the resolution cells size increase responsive to the distance between the radar and the target; therefore, the greater this distance, the worsen the displacement measurement accuracy is.

From GB2243739 and GB1219410 radar systems are known, which do not use the interferometric technique. In such systems, a transponder is provided at the/each target, so that the signal, as received by the target, is frequency-shifted before being sent back towards the radar. Such systems are conceived to detect the absolute position of remote objects, and are neither suitable for directly measuring the displacement of a moving target, nor for recognizing a known target from other unidentified moving objects. Frequency shifting transponders are used, in particular, to separate the transmission channel from the reception channel, or to assist an absolute distance measurement that is carried out by means of a CWFM radar system. In particular, GB2243739 describes a CWFM distance measurement system in which a frequency shift is applied to the signal before being retransmitted. As a result, forward and return paths can be separated, which enables operation at sub-microwave frequencies even without using highly directive antennas. To this purpose, frequency shift offset must be large enough to prevent instability to both measurement and target unit; for an emission frequency of a few hundred megahertz a typical offset value is about 100 kHz, i.e. about three is orders of magnitude lower than the emission frequency. Furthermore, both documents relates to simultaneous use of several transponder, in combination with particular communication protocols (GB2243739) or with time-sharing techniques (GB1219410).

Furthermore, even if remote object displacements can be calculated as the difference between successive positions as detected by such radar systems, these displacements are many orders of magnitude higher than displacements which can be typically measured by interferometric radar.

### SUMMARY OF THE INVENTION

It is therefore a feature of the present invention to provide a method for providing an measure of the displacement of a moving remote object, i.e. of a target, by means of an interferometric radar system, in which the measure is not affected by clutter, i.e. by a noise received from other objects that may lie in the scenario.

A further feature of the present invention is to provide such a method, which allow to resolve more than one target in a same radar scenario or in a same resolution cell of a radar scenario, as defined by common interferometric radar techniques

It is a particular feature of the present invention to provide such a method, in which measurement accuracy is not substantially affected by the distance between the radar and the target.

It is also a feature of the invention to provide such a method that is easy and cheap to be put into practice.

It is also a feature of the invention to provide such a method that can be used for estimating a displacement in a radar scenario of a remote ground based object such as landslides, subsidence and bradyseism, civil works such as buildings, bridges, off-shore structures, river banks, open pits

These and other objects are achieved by a method for estimating a displacement of a remote object in a radar scenario by means of an interferometric radar, the method comprising the steps of:

transmitting from the radar a first emitted signal at a first instant and a second emitted signal at a second instant, the first emitted signal and the second emitted signal having an emission frequency and an emission amplitude;

receiving at the remote object the first emitted signal and the second emitted signal;

receiving at the radar a first response signal and a second response signal from the radar scenario, the first response signal and the second response signal comprising respectively a first response signal remote objects portion and a second response signal remote portion;

demodulating the first response signal and the second response signal, the step of demodulating creating a first demodulated response signal and a second demodulated response signal comprising respectively a first demodulated frequency-shifted signal and a second demodulated frequency-shifted signal;
extracting a first phase and a second phase respectively from the first demodulated frequency-shifted signal and from the second demodulated frequency-shifted signal;

computing a difference between the first phase and the second phase;

computing a displacement of the remote object, the displacement responsive to the difference between the first phase and the second phase; the main feature of the method is that it comprises furthermore the steps of:

prearranging a transponder at the remote object;

frequency-shifting, at the transponder, the first emitted signal and the second emitted signal as received at the remote object, the frequency-shifting step creating a first frequency-shifted signal and a second frequency-shifted signal that have a shifted frequency that differs from the emission frequency by a predetermined frequency-shift, and retransmitting from the transponder the first frequency-shifted signal and the second frequency-shifted signal, such that the first remote object response signal portion and a second remote object response signal portion respectively comprise the first frequency-shifted signal and a second frequency-shifted signal,

such that the first and the second demodulated frequency-shifted signal have a frequency that differs from the emission frequency responsive to the frequency shift.

In particular, the frequency shift is selected such that the wavelength of the first and the second emitted signal differs from the wavelength of the first and the second frequency-shifted signals in such a way that the displacement of the remote object is univocally established with respect to the difference between the first phase and the second phase, which enables the use of an interferometric technique.

In particular, the frequency-shift f_{d} is at least six orders of magnitude lower than the emitted frequency.

In particular the step of demodulating is a coherent demodulation that provides multiplying the first response signal and the second response signal respectively by the first emitted signal and by the second emitted signal, wherein the first frequency-shifted signal and the second frequency-shifted signal are subject to a frequency shift that is in absolute value equal to the emission frequency, and has the opposite sign.

In particular the phase-extracting step comprises the steps of:

multiplying the first demodulated response signal and the second demodulated response signal by a phasor, the phasor being a periodic signal having a frequency equal to the frequency-shift, the multiplying step creating a first baseband signal and a second baseband signal which respectively comprise a first baseband demodulated frequency-shifted signal and a second baseband demodulated frequency-shifted signal;

filtering the first baseband signal and the second baseband signal, the filtering step suppressing portions of signals whose frequency is in absolute value greater than an unilateral filter bandwidth, the filtering step producing a first baseband filtered signal and a second baseband filtered signal;

computing the first phase and the second phase respectively from the first baseband filtered signal and from the second baseband filtered signal, wherein the predetermined frequency-shift is greater than the unilateral filter bandwidth, such that the clutter is suppressed during the filtering step, translated to a frequency that is equal to the frequency-shift after the demodulating step and the multiplying step that are consecutively applied to the first and to the second response signal. One of the limit of the prior art is therefore overcome by the present invention.

In particular a further remote object is present in the radar scenario, and the method provides the steps of:

prearranging a further transponder at the further remote object;

further frequency-shifting, in the transponder, the first emitted signal and the second emitted signal as received at the further remote object, the further frequency-shifting step creating a further first frequency-shifted signal and a further second frequency-shifted signal that have a further shifted frequency that differs from the emission frequency by a further predetermined frequency-shift, and retransmitting from the further transponder the further first frequency-shifted signal and the further second frequency-shifted signal;

further phase-extracting, the further phase-extracting step extracting a further first phase and a further second phase respectively of the further first demodulated frequency-shifted signal and of the further second demodulated frequency-shifted signal;

computing a difference between the further first phase and the further second phase;

computing a displacement of the further remote object, the displacement responsive to the difference between the further first phase and the further second phase.

It is therefore possible to measure the displacement of more targets that are present in the radar scenario, by arranging a transponder at each of them. Each transponder must be adapted to carry out a frequency shift of the signals that come from the radar, according to a respective specific frequency-shift, which must be different from the frequency-shift used by any other transponder. Another drawback the prior art interferometric radar systems is therefore overcome by the method according to the present invention.

Advantageously, the further frequency-shift is greater than the unilateral filter bandwidth of the radar. Advantageously, furthermore, the further frequency-shift differs from the frequency-shift by an amount that is greater than the unilateral filter bandwidth of the radar. This allows extending the above described phase extracting procedure, which provides multiplying the response signal by a suitable phasor, and provides furthermore a filtering step according to a prefixed unilateral filter bandwidth, to the case of a plurality of targets present in the radar scenario. In fact, by multiplying each demodulated signal by a phasor which has a frequency that is equal to the frequency-shift, the first and the second demodulated frequency-shifted signal fall within the filter band, whereas, if the phasor frequency is equal to the further frequency-shift, the further first and the further second demodulated frequency-shifted signal fall within it, such that the first and the second demodulated frequency-shifted signal can be separated from the respective further demodulated signal by means of respective filtering steps, according to this unilateral filter bandwidth.

In particular, the first emitted signal and the second emitted signal comprise a repeated sequence of tones that have:

a duration such that a tone reflected by a remote object that is located at a predetermined distance from the radar is received at the radar before that the radar stops transmitting the tone, such that a coherent demodulation of the tone is carried out at the radar, the predetermined distance being called the maximum radar range of the radar;

respective different frequencies, the frequencies differing by a predetermined frequency pitch, such that an unambiguous range limit is defined, i.e. a distance is defined that is related to the frequency pitch, and within which the displacement of a remote object may be established without ambiguity by the radar;

such that the radar scenario set between the radar and the unambiguous range limit is subdivided in a plurality of resolution cells that are equal in number to the tones of the sequence, and the radar measures a displacement of the remote object in a predetermined cell selected from the plurality of resolution cells, the predetermined cell called an observed resolution cell,
wherein the frequency pitch is set such that the unambiguous range limit is greater than the maximum radar range,
   wherein the step of extracting comprises the steps of:

acquiring a first sequence of sample values of the first demodulated response signal and a second sequence of sample values of the second demodulated response signal, each sample value of the first sequence and each sample value of the second sequence corresponding to a tone of the sequence of tones, each of the sample values comprising a signal portion responsive to a respective demodulated frequency-shifted signal;

application of the inverse discrete Fourier transform (IDFT) to the first sequence of sample values and to the second sequence of sample values, such that a first transformed sequence of sample values of the first demodulated response signal and a second transformed sequence of sample values of the first demodulated response signal are obtained, each sample value of the first transformed sequence and each sample value of the second transformed sequence associated to one resolution cell,

wherein the signal portion relative to a respective demodulated frequency-shifted signal is migrated from the observed resolution cell into one of the migrated resolution cells responsive to the value of the frequency shift.

extracting from the first transformed sequence and from the second transformed sequence a first sample value and a second sample value which are associated to the migrated resolution cell;

computing the first phase and the second phase of respective sample values which are associated to the migrated resolution cell

In particular, said predetermined frequency pitch is a positive pitch.

In particular, said frequency pitch is set such that:

the unambiguous range limit is substantially double of the maximum radar range;

the resolution cells, whose diameter is less or equal to the maximum radar range, are equal in number to the resolution cells, which are called displaced resolution cells, that have a diameter set between the maximum radar range and the unambiguous range limit,

The radar may be a SFCW radar, more in particular it may be a SFCW-SAR radar or a SFCW-RAR radar.

This way, the displacement of the remote object that is measured by a SFCW radar is not affected by clutter, since clutter is not subject to migration into the migrated cell, which is free from clutter due to the fact that it is located beyond the maximum radar range.

Preferably, the phase-extracting step is preceded by a step of filtering the first and the second demodulated signal through a predetermined unilateral filter bandwidth, in order to reduce noise, wherein the frequency-shift is less than the unilateral filter bandwidth.

In particular, the first emitted signal and the second emitted signal comprise the sequence of tones above defined, in the observed resolution cell is present a further remote object, and the further frequency-shift is set such that the signal portion which is associated to a respective further demodulated frequency-shifted signal is migrated from the observed resolution cell into a further migrated resolution cell of the displaced resolution cells, that is different from the migrated cell and according to the frequency-shift.

Therefore, it is possible to measure the displacement of a plurality of targets that are located in the same resolution cell of a radar scenario, arranging at each target a transponder; each transponder must be adapted to carry out a frequency shift of the signals that come from the radar according to a respective specific frequency-shift, which must be different from the frequency-shift used by any other transponder that is associated to a target in the same cell. This way, the method according to the present invention overcomes another aforementioned prior art interferometric radar drawback, also in the case of a SFCW radar. In fact, each target is displayed in a respective migrated cell of the radar scenario, and therefore the respective displacements can be measured by the radar independently from one another.

Advantageously, the method provides the steps of:

prearranging an amplifier at the remote object;

amplifying, at the amplifier, the first and the second emitted signal as received at the transponder, or the first and the second frequency-shifted signal, such that the first frequency-shifted signal and the second frequency-shifted signal have an amplified amplitude that is greater than the emission amplitude.

In particular, the amplifying step is carried out in an amplifier that is associated with the transponder, which is then called an active transponder, and carries out the step of frequency-shifting the first and the second emitted signal. This way, a first and a second frequency-shifted signal are created, which have the same wavelength λ; the antenna, the amplifier and the transponder have respective gain factors G, G_{A} and Gₐ, the transponder has a radar equivalent surface i.e. a “radar cross section” σₜ, wherein the wavelength, the antenna, the transponder and the supplier are selected such that the inequality

(λ²/4π)Gₐ²G_{A}>σₜ

is verified. Preferably, the method provides the steps of:

prearranging on the remote object at the amplifier of an accumulator of electric energy;

electrically connecting the amplifier in order to ensure an electric supply to the supplier

charging the accumulator.

Preferably, the method provides a step of prearranging an electric energy generating device, in particular a solar photovoltaic converter, to carry out the step of charging the accumulator.

The method provides a step of fixing the frequency-shift and/or the further frequency-shift from a remote position, preferably by means of wireless communication techniques, in particular by means of WIFI communication techniques. In case a plurality of targets is present in the radar scenario or in a same resolution cell of it, the targets may be equipped of respective transponder, that are then remotely tuned to respective frequency shifts, for instance, from a control board proximate to the radar.

The steps of:

extracting a first and a second phase;
computing a difference between the first phase and the second phase;

computing a displacement of the remote object,

may be carried out through an analogue technique, or through a digital technique, or through a combination of such techniques. The digital approach makes it easier to carry out the method. For example, in the case of a plurality of remote objects that are associated to respective transponders, all phasor multiplications can be performed simultaneously, starting from the same demodulated response signal in digital form without switching the radar receiver. Advantageously, in case of use of the SFCW technique, the sampled demodulated response signal are transcoded from analogue to digital, in order to digitally performing subsequent steps, i.e. running the inverse discrete Fourier transform, extracting the migrated samples, computing the first and the is second phase, digitally of computing the displacement.

The above-mentioned objects are also achieved by the use of an apparatus comprising:

a receiving/transmitting antenna that is suitable for receiving an emitted signal from a radar and for transmitting a response signal portion towards the radar;

a square-wave signal generator;
a switch that has
a short-circuit position in which the emitted signal, as received at the antenna, is short-circuited;
an open-circuit position in which the emitted signal, as received at the antenna, is reflected and transmitted as said response signal portion to the radar by means of the antenna;

an actuating means for bringing the switch from the short-circuit position to the open-circuit position, and vice-versa, respectively when the square wave signal changes from a zero value to a non-zero value of a square-wave signal that is generated by the generator, and vice-versa;

such that the response signal portion is a product between the emitted signal as received at the transponder and the square-wave signal. In other words, the switch modulates the amplitude of the emitted signal as received, from the emission frequency into a shifted frequency. The apparatus may even comprise a battery adapted to provide electric supply, in which case the apparatus can work as an active transponder.

The above listed features are also achieved by the use of an apparatus comprising:

a receiving antenna that is suitable for receiving an emitted signal from a radar;

an amplifier for amplifying the emitted signal as received at the receiving antenna;

a local oscillator that is suitable for generating a sine-wave signal;

a signal mixer that is suitable for multiplying the sine-wave signal by the emitted signal as received, such that a frequency-shifted signal is obtained according to a frequency-shift equal to the frequency of said sine-wave signal;

a means selected from the group comprised of:
a circulator, which allows the use of one antenna, which is suitable both for receiving and for transmitting a radar signal;
a separate transmitting antenna for transmitting the frequency-shifted signal, in which case the circulator is not necessary.

This way, the coupling of the sender with the receiver is reduced to minimum, which limits the risk of self-oscillations.

The/each antenna may be selected from the group comprised of:

a horn antenna;

a patch antenna. The/each antenna is chosen according to the operative frequency and band, as well as according to radiation pattern that is required by the application.

Preferably, the local oscillator is selected from the group comprised of:

a quartz oscillator;

a SAW oscillator.

The apparatus may comprise a battery to provide the amplifier an electric supply such that a suitable autonomy may be ensured; an electricity generator may be also provided, in particular a photovoltaic generator, which is suitable for recharging the battery.

According to another aspect of the invention, the use of a transponder for estimating a displacement of a remote object in a radar scenario by means of an interferometric radar, wherein said transponder is prearranged at said remote object, and wherein said transponder is associated with a radar system that operates with the above described method. In particular, the object is a ground-based object selected among:

landslides,

subsidence and bradyseism,

civil works such as buildings, bridges, off-shore structures,

river banks,

open pits.

### BRIEF DESCRIPTION OF THE DRAWINGS

The invention will now be made clearer with the following description of an embodiment thereof, exemplifying but not limitative, with reference to the attached drawings wherein:

FIG. 1 diagrammatically shows the operation of an interferometric radar system, according to formula [1];

FIG. 2 diagrammatically shows the operation of an interferometric radar system, in which a target is provided with a transponder, according to the invention;

FIG. 3 shows a block diagram of the method according to the invention;

FIG. 4 shows a block diagram of an exemplary embodiment of the phase extracting step;

FIG. 5 diagrammatically shows two consecutive demodulations of a return signal that comes back from the radar scenario, i.e. a first coherent demodulation and a second demodulation that is carried out by multiplying the result of the first demodulation by a phasor whose frequency is equal to the frequency-shift of the transponder;

FIG. 6 shows a radar scenario, in which two targets are present;

FIG. 7 shows a demodulated signal that is obtained through a coherent demodulation of response signal coming from the radar scenario, wherein two targets are provided with respective transponder, and the unilateral filter bandwidth, in the case of a CW radar;

FIGS. 8 and 9 show a signals that is obtained by further demodulating the demodulated signal of FIG. 8, by means of phasors whose frequencies are equal to the two frequency-shift of the two transponders;

FIG. 10 shows the temporal evolution of the frequency of the signal that is used by a SFCW radar system;

FIGS. 11 and 12 diagrammatically show how a radar scenario is analysed, respectively, by a SFCW radar and by a SFCW-SAR or a SFCW-RAR radar;

FIG. 13 shows a block diagram of an exemplary embodiment of the phase extracting step, in the case of a SFCW radar;

FIG. 14 shows a demodulated signal that is obtained by a coherent demodulation of a response signal coming from the radar scenario, wherein two targets are provided with respective transponder, and the unilateral filter bandwidth, in the case of a SFCW radar;

FIG. 15 is a diagrammatical view of the migration of a resolution cell according to an exemplary embodiment of a SFCW radar;

FIG. 16 shows the radar scenario of FIG. 11, in which two targets are present in the same resolution cell;

FIG. 17 is a diagrammatical view of the migration of a resolution cell according to an exemplary embodiment of a SFCW radar, in the case of two targets in the same resolution cell;

FIGS. 18, 19 and 20 show diagrammatically three apparatus that can be used to carry out the method according to the invention;

FIG. 21 is an alternate embodiment of the apparatus of FIG. 20, in which a solar panel is provided to supply energy to the transponder.

### DESCRIPTION OF SOME EXEMPLARY EMBODIMENTS

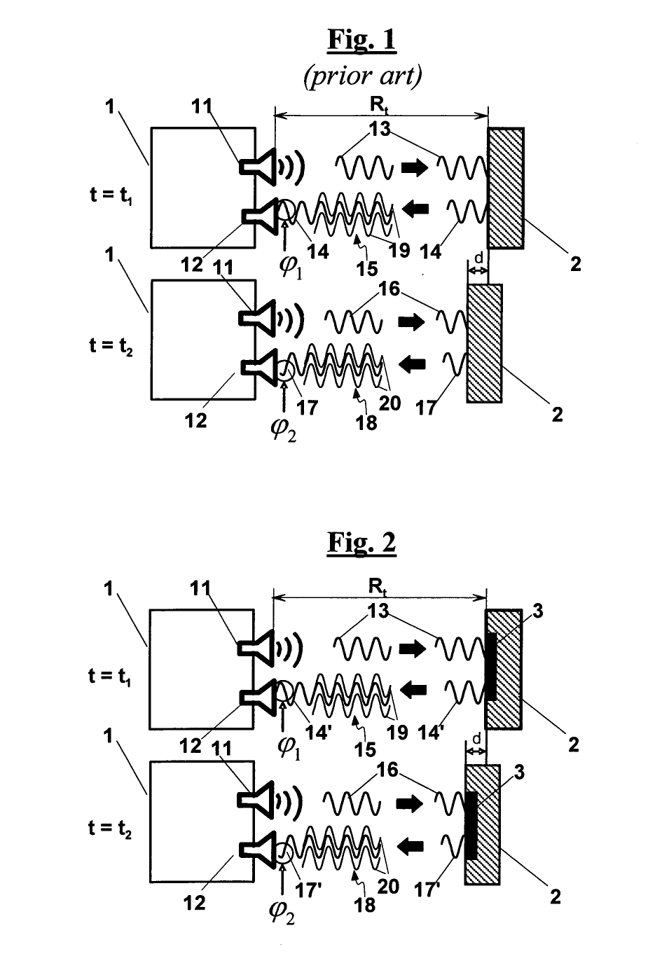

The operation of prior art interferometric radar systems is diagrammatically shown in FIG. 1. A first signal 13 and a second signal 16 are respectively transmitted at instants t₁ and t₂, by means of a transmitting antenna 11 of a radar 1; signals 13 and 16 reach a remote object, i.e. a target 2 that is located at a distance Rₜ from radar 1. Target 2 reflects signals 13 and 16, producing respective first and second response signals 14 and 17, which form, along with the signals 19 and 20 reflected from the rest of the scenario, a first return signal 15 and a second return signal 18 that are received by a receiving antenna 12 of radar 1.

Between time t₁ and time t₂, target 2 performs a displacement d, for example a displacement towards radar 1, and the phase φ of response signal produced by target 2 changes from a value φ₁, (signal 14) into a value φ₂ (signal 17): the displacement d of target 2 can therefore be measured by means of formula [1].

A method will be now shown according to the invention, that overcomes the aforementioned drawbacks of prior art interferometric radar systems.

CW radar

With reference to FIGS. 2, 3 and 5, the method provides a step 105 of prearranging a transponder 3 at target 2, so that transponder 3 makes the same displacement d as remote object 2, between time t₁ and time t₂. In order to measure displacement d, a step 110 is provided of transmitting a first signal 13 at time t₁ and a second signal 16 at time t₂. First and second signal waveform may be a sinusoid, in which case it can be represented by:

s(t)=to e^{(j2πf}^{₀}^{t)}.

Both signals 13 and 16, as received at target 2 (step 120) can be expressed in a similar way, for example first emitted signal 13 as received at target 2, can be written:

x(t)=L_{T}s(t−τ/2)=L_{T to} e^{[j 2πf}^{₀}^{(t-τ/2)]}, [3]

where
τ is the overall time taken by signal 13 to reach target 2 and then by a response signal to travel back from target 2 to radar 1;

L_{T} is the propagation loss between the radar and the transponder.

Transponder 3 is adapted to carry out a step 130 of shifting the frequency of transmitted signals 13 and 16, thus creating respective frequency-shifted signals 14′ and 17′ that have a same shifted frequency f₀+f_{d} that differs from emission frequency f₀ by a frequency-shift f_{d} of transponder 3. For example, first frequency-shifted signal 14′ can be written:

$$\begin{matrix}y ( t ) = {G}_{A}^{\frac{1}{2}} {L}_{T} s ( t {-}_{T} / 2 ) {e}^{[ j ( 2 π {f}_{d} t + {ϕ}_{d} ) ]} \\ = {G}_{A}^{1 / 2} {L}_{{T}_{to}} {e}^{[ j 2 π {f}_{0} ( t {-}_{T} / 2 ) ]} {e}^{[ j ( 2 π {f}_{d} t + {ϕ}_{d} ) ]} .\end{matrix} \qquad [ 4 ]$$

where G_{A} is the gain of transponder 3.

Frequency-shifted signal 14′ is retransmitted by transponder 3 (step 140), and forms a remote object portion of first response signal 15, which also contains other signals 19 that come from the rest of the radar scenario. When first response signal 15 reaches receiving antenna 12 of radar 1 (step 150), the portion of it that consists of frequency-shifted signal 14′ can be expressed as:

r(t)=L_{R}y(t−τ/2)=G_{A}^{1/2}L_{R}L_{T to} e^{[j2πf}^{₀}^{(t-τ)]}e^{{j[2πf}^{_{d}}^{(t-τ/2)+φ}^{_{d}}^{]}} [5]

where L_{R} is the propagation loss along the path from the transponder to the radar. Let be:

K=GA^{1/2}L_{R}L_{T}A; [6]

if a coherent demodulation 160 of signal 15 is carried out, in particular, if a coherent demodulation is carried out by multiplying first and second response signals 15 and 18 by the signal that is currently emitted, which can be expressed as first and second emitted signal 13 and 16 in terms of e^{(-j2πf}^{₀}^{t)}, first frequency-shifted signal 14′ (equation [5]) can be written:

r(t)e^{(-j2πf}^{₀}^{t)}=Ke^{(-j2πf}^{₀}^{r)}e^{{j[2πf}^{_{d}}^{(t-τ/2)+φ}^{_{d}}^{]}}. [7]

In other words, first frequency-shifted signal 14′ is changed into a demodulated frequency-shifted signal 21, whose frequency is ±f_{d}, which belongs to a first demodulated signal 25 (FIG. 5); without transponder 3, corresponding response signal 14 from target 2 (FIG. 1) would have been changed into a baseband response signal together with the clutter portion 19; transponder 3, instead, allows separately analysing frequency-shifted signal 14′, in particular a phase-extracting step 170 can be carried out, which overcomes one of the prior art drawbacks. As shown in FIG. 5, clutter portion 19 is not subject to frequency-shifting step 130; therefore, by demodulating step 160, is translated into baseband. The same can be repeated for second frequency-shifted signal 17′. The difference (φ₂−φ₁) (step 180) and displacement d (step 190) of target 2 can then be computed, according to equation [1].

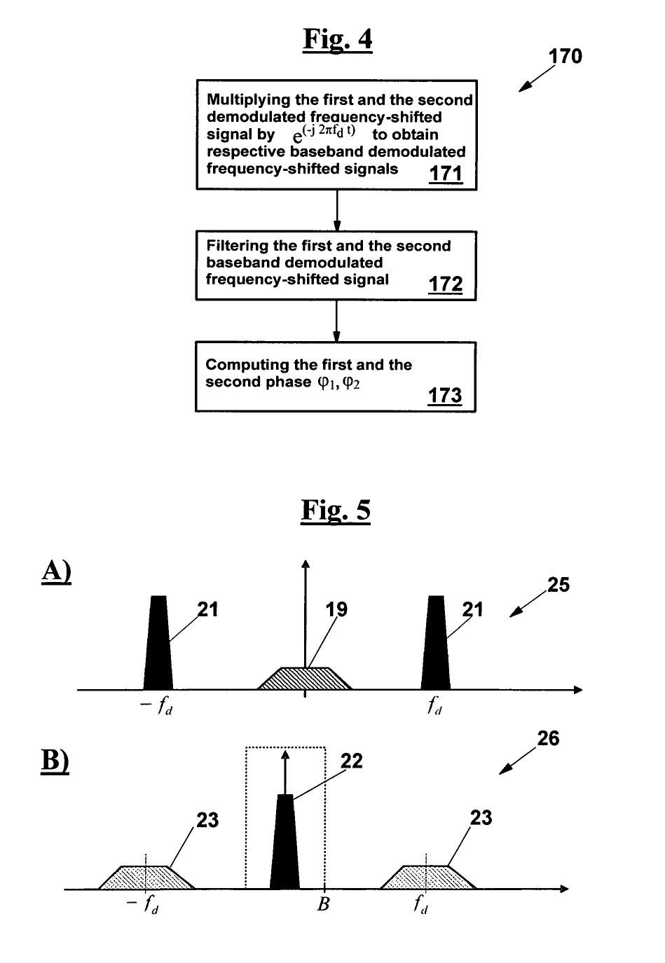

With reference to FIGS. 4 and 5, an exemplary embodiment of phase-extracting step 170 provides further demodulating 171 demodulated frequency-shifted signals, by multiplying them by phasor F(t)=e^{(-j2πf}^{_{d}}^{t)} whose frequency is equal to frequency shift f_{d} of transponder 3. This way, first demodulated frequency-shifted signal 21 of first demodulated signal 25 is changed through step 171 into a baseband frequency-shifted demodulated signal 22 which can be written:

r(t)e^{(-j2πf}^{₀}^{t)}e^{(-j2πf}^{_{d}}^{t)}=Ke^{(-j2πf}^{₀}^{τ)}e^{[-j[2πf}^{_{d}}^{τ/2-φ}^{_{d}}^{)]}, [8]

whereas clutter portion 19 of first demodulated signal 25 is shifted to frequencies ±f_{d}. In other words, further demodulating step 171 changes first demodulated signal 25 into a signal 26 which comprises baseband frequency-shifted demodulated signal 22, and a clutter portion 23, which can be easily filtered away from signal 26 by a low-pass filtering step 172, provided that:

f_{d}>B; [9]

where B is called unilateral filter bandwidth of the receiver. Filtering step 172, which may be carried out by means of a conventional equipment, suppresses the portions of signal 26 whose frequency absolute value is higher than an unilateral filter bandwidth B, and creates a baseband filtered signal, that is substantially coincident to frequency-shifted demodulated signal 22, whose phase φ can be easily calculated (step 173), taking into account equation [8]:

φ=2πf₀τ−2πf_{d}τ/2+φ_{d}=−2π(f₀+f_{d}/2)τ+φ_{d}. [10]

Transponder 3 moves together with target 2, according to the following relationship:

Rₜ(t)=R₀+d(t), [11]

where R₀ is the starting position and d(t) is a displacement, therefore phase φ is a time-dependent quantity. For instance, transponder frequency-shift f_{d}, is set between 10¹ to 10² kHz, for an emitted frequency f₀ of 17 GHz, i.e. frequency-shift f_{d} is about six orders of magnitude lower than the emitted frequency; therefore:

c/(f₀+f_{d}/2) [symbol] /f₀=λ₀; [12]

since

τ(t)=2Rₜ(t)/c; [13]

a combination of equations [ ] gives:

φ(t)=−(4π/λ₀)[2R₀+d(t)]+φd=−(4π/λ₀)d(t)+φₖ; [14]

neglecting the constant-phase term φₖ:

d(t)≅(λ₀/4π)(φ(t)), [15]

which is equivalent to formula [1], where the displacement is univocally related to phase change φ(t).

In other words, the frequency shift must be selected such that the wavelength of the first and the second emitted signal differs from the wavelength of the first and the second frequency-shifted signals in such a way that the displacement of the remote object is univocally established with respect to the difference between the first phase and the second phase, which enables the use of an interferometric technique.

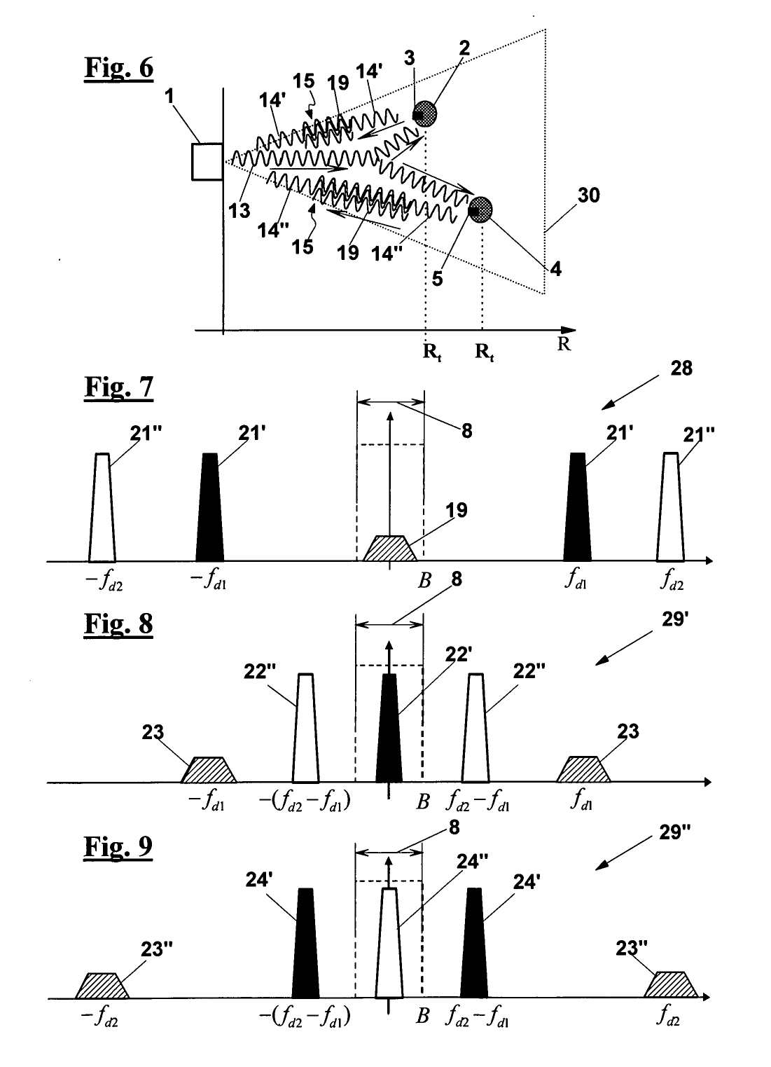

With reference to FIGS. 6, 7, 8, a further target 4 is present in the radar scenario, in addition to target 2. In this case, the method provides a step of prearranging a further transponder 5 at further target 4; further transponder 5 has a frequency shift f_{d2} that is different from the frequency shift f_{d1} of transponder 3, as hereinafter indicated. Therefore, the transponder 3 and the further transponder 5 carries out respective steps of frequency-shifting the first emitted signal 13 and the second emitted signal 16, as respectively received at target 2 and at further target 4. With reference to first emitted signal only, the frequency shifting steps produce a first frequency-shifted signal 14′ and a further first frequency-shifted signal 14″ that have respectively shifted frequency f₀+f_{d1} and a further shifted frequency f₀+f_{d2}, which is different from shifted frequency f₀+f_{d1}. First frequency-shifted signal 14′ and further frequency-shifted signal 14″ and clutter 19 form a first response signal 15 that is received by antenna 12 of radar 1. As in case of a single target 2, frequency-shifted signal 14′ and further frequency-shifted signal 14″ can be spaced away from clutter portion 19 by a coherent demodulation step 160, that produces a demodulated signal 28. Demodulated signal 28 (FIG. 7) comprise a demodulated frequency-shifted signal 21′ and a further demodulated frequency-shifted signal 21″, that are respectively obtained from frequency-shifted signal 14′ and from further frequency-shifted signal 14″. Further demodulating steps 171 (FIG. 4) are then provided, in which demodulated signal 28 is respectively multiplied by phasor F₁(t)=e^{(-j2πf}^{_{d1}}^{t)} and by a further phasor F₂(t)=e^{(-j2πf}^{_{d2}}^{t)}, to respectively obtain signals 29′, 29″.

Signal 29′ comprises baseband frequency-shifted demodulated signal 22′, which is obtained by multiplying demodulated frequency-shifted signal 21′ by phasor e^{(-j2πf}^{_{d1}}^{t)}, as well as out-of-baseband signal 22″ and a clutter portion 23. Signal 29″ comprises, instead, further baseband frequency-shifted demodulated signal 24′, which is obtained by multiplying further demodulated frequency-shifted signal 21″ by the further phasor, as well as out-of-baseband signal 24″ and a clutter portion 23′. In both cases, baseband frequency-shifted demodulated signal 22′ and 24′ can be easily isolated from the rest of the signal 29′ and 29″ by a low-pass filtering step 172, provided that:

f_{d1}>B, f_{d2}>B; [16]

|f_{d1}−f_{d2}|>B, [17]

where B is still the unilateral filter bandwidth of the receiver. Filtering step 172 is suppresses the portions of signal 28 whose frequency absolute value is higher than the unilateral filter bandwidth B, and creates respective baseband filtered signal, that are substantially coincident to frequency-shifted demodulated signals 21′ and 21″, whose respective phases φ₁ and φ₂ can be easily calculated (step 173), as well as displacements d1 and d2 of targets 2 and 4, mutatis mutandis, with reference to formulae [8] to [15].

The example can be obviously generalized to the case of a radar scenario in which n≧1 targets are present. In this case, each target i will be provided with a respective transponder which has a frequency shift f_{di}, where f_{di≠}f_{dj}, j=1 . . . n. In the step 171, each demodulated frequency-shifted signal will be multiplied by a respective phasor Fᵢ(t)=e^{(-j2πf}^{_{di}}^{t)}.

Another drawback of the prior art It is therefore overcome by the method according to the invention.

In order to perform digitally demodulating step 171 (i.e. multiplication by phasor e^{(-j2πf}^{_{d}}^{t)}), baseband filtering 172, of phase computing 173 and of displacement computing 180,190, demodulated response signals 25 and/or 28 may be transcoded from analogue to digital. In particular, filtering 172 is carried out by means of a FIR (Finite Impulse Response) filter. Digitally carrying out such steps improves the flexibility of the method: in particular, if n transponders are in use, it is possible simultaneously multiplying demodulated signals by respective phasors Fᵢ, i=1 . . . n, starting from the same demodulated response signal, which has been made available in digital form, without switching the radar receiver.

SFCW Radar.

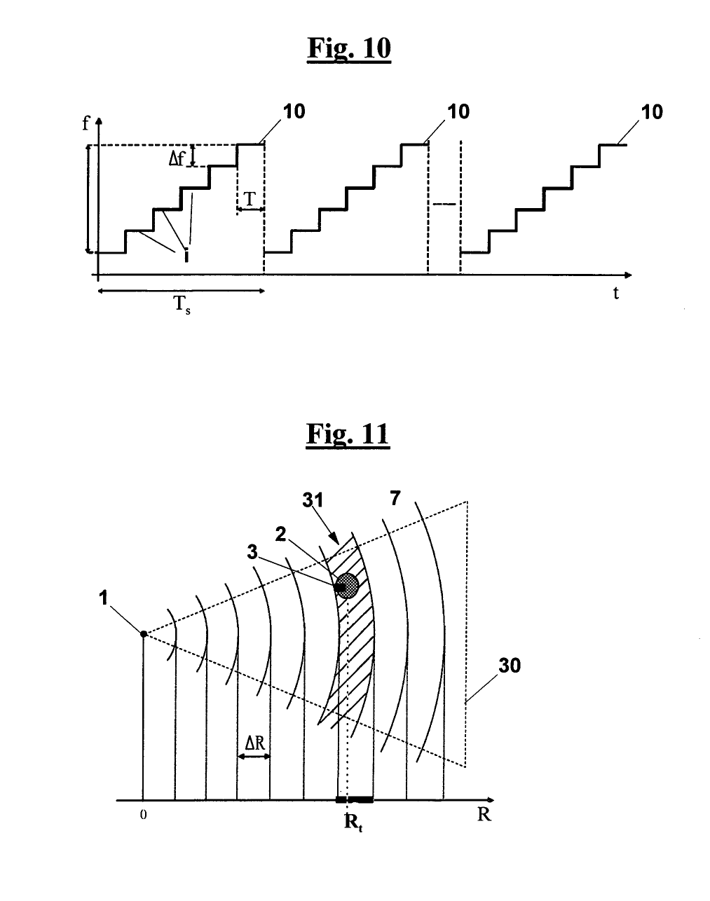

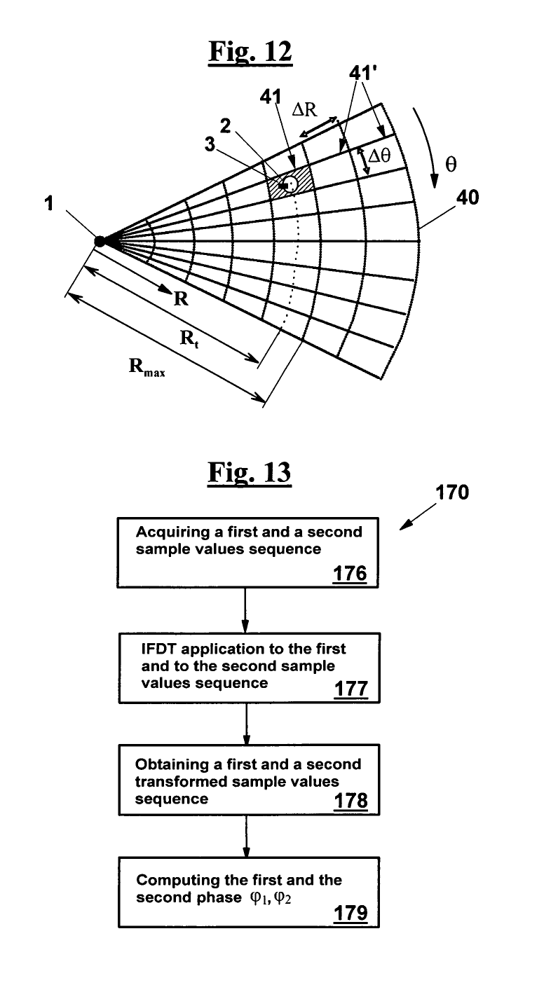

With reference to FIGS. 1 and 10, first emitted signal 13 and second emitted signal 16 provide the repetition of a sequence 10 of N tones which have the same duration T. If duration T of a tone is set such that the corresponding return tone coming from a target that is located at a distance Rₘₐₓ from radar 1 is received at radar 1 before radar 1 stops to transmit the tone, i.e. if

T=2Rₘₐₓ/c, [18]

it is possible to carry out a coherently demodulating signal 14′. For a predetermined T value, equation [18] defines therefore a distance Rₘₐₓ that is is the maximum distance that can be reached by a radar that carries out coherently demodulating return signals.

Each tone j of sequence 10 is a periodic signal, in particular a sinusoidal signal, which has a frequency fⱼ. The difference between the frequencies may be a multiple of a prefixed amount Δf, in particular, the tone may be sequentially ordered such that the frequency increases from the first to the last tone according to a prefixed frequency pitch Δf, also called a frequency step. The sequence is repeated whenever a time Tₛ has elapsed from the last sequence beginning; in particular, time Tₛ can be expressed as

Ts=(N−1)T. [19]

For SFCW radar, an unambiguous range limit R_{U} is defined, which indicates the distance within which a target can be unambiguously resolved in range:

R_{U}=c/2 1/Δf, [20]

therefore:

TΔf=R_{U}/Rₘₐₓ [21]

FIG. 11 shows schematically a SFCW radar 1 and a radar scenario 30 which is subdivided into N resolution cells 31 i.e. “range-bin”, each resolution cell corresponding to a tone of sequence 10. Resolution cells 31 are defined by concentric spherical shells about radar 1, which have the same range R, depending upon tone duration T.

The following shows how the method according to the invention overcomes well-known prior art interferometric SFCW radar systems drawbacks, i.e. the presence of clutter and the impossibility of resolving more than one targets in the same resolution cell 31.

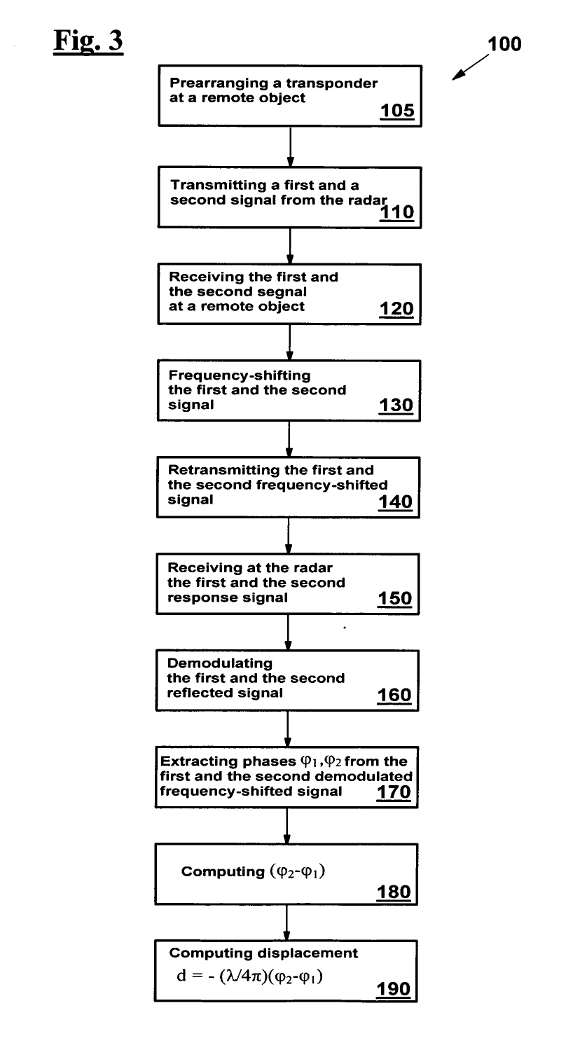

With reference to FIGS. 2 and 11, first signal 13 emitted at time t₁ and second signal 16 emitted at time t₂ during transmitting step 110 (FIG. 3), can be written:

$$s ( t ) = {\sum }_{k = 0}^{N - 1} A {e}^{[ j 2 π ( {f}_{0} + k Δ f ) t ]} rect [ ( t - kT ) / T ] \qquad [ 22 ]$$

As shown in FIGS. 11 and 12, a transponder 3 is arranged at a target 2 that is located at a distance Rₜ=cτ/2 from radar 1. Emitted signal 13, as received by target 2, can be expressed as:

$$\begin{matrix}x ( t ) = {L}_{T} s ( t {-}_{T} / 2 ) \\ = {L}_{{T}_{to}} {\sum }_{k = 0}^{N - 1} {e}^{[ j 2 π ( {f}_{0} + k Δ f ) ( t {-}_{T} ( t ) / 2 ) ]} rect [ ( t {-}_{T} ( t ) / 2 - kT ) / T ] .\end{matrix} \qquad [ 23 ]$$

Transponder 3 carries out frequency-shifting step 130 of transmitted signals 13 and 16, which creates frequency-shifted signals 14′ and 17′. For example, first frequency-shifted signal 14′, as received by radar 1 in response signal 15 (step 150) along with clutter 19, is:

$$y ( t ) = {G}_{A}^{1 / 2} {L}_{{T}_{to}} {\sum }_{k = 0}^{N - 1} {e}^{\{ j 2 π ( {f}_{0} + k Δ f ) ( t {-}_{T} ( t ) / 2 ) ] \}} rect [ t {-}_{T} ( t ) / 2 - kT ) / T ] {e}^{[ j ( 2 π {f}_{d} t + {ϕ}_{d} ) ]} . \qquad [ 24 ]$$

In particular, the signal portion of frequency-shifted signal 14′ in response signal 15 can be written:

$$r ( t ) = K {\sum }_{k = 0}^{N - 1} {e}^{[ j 2 π ( {f}_{0} + k Δ f ) ( {t}_{- T} ( t ) ) ]} rect [ ( t {-}_{T} ( t ) - kT ) / T ] {e}^{\{ j [ 2 π {f}_{d} ( t {-}_{T} ( t ) / 2 + {ϕ}_{d} ] \}} , \qquad [ 25 ]$$

where K is still defined by equation [6].

A coherent demodulation 160 of response signal 15, which is carried out by means of phasor e^{(-j2πf}^{₀}^{t)}, changes frequency-shifted signal 14′ into demodulated frequency-shifted signal 21:

$$r ( t ) {e}^{( - j 2 π {f}_{0} t )} = K {\sum }_{k = 0}^{N - 1} {e}^{[ j 2 {π ( {f}_{0} + k Δ f )}_{T} ( t )} rect [ ( t {-}_{T} ( t ) - kT ) / T ] {e}^{[ j ( 2 π {f}_{d} ( t {-}_{T} ( t ) / 2 + {ϕ}_{d} ) ]} . \qquad [ 26 ]$$

Phase extracting step 170 of demodulated frequency-shifted signal 21 may be carried out as described above. In alternative, with reference to FIGS. 1 and 4, a collecting step 176 of sample values of demodulated frequency-shifted signal 21 (equation [26]) can be performed with a pitch equal to duration T of each tone of sequence 10, for example a collecting of values that demodulated frequency-shifted signal 21 has at instants T, 2T, 3T, . . . . This way, a sample (complex) values vector is obtained, under the approximation [12]:

$$\begin{matrix}R ( k ) = R ( t ) {\vert}_{t = kT} = K {e}^{( j {f}_{d} )} {\sum }_{k = 0}^{N - 1} {e}^{[ - j2π ( {f}_{0} + {f}_{d} / 2 + k Δ f ) {(}_{T} ( t ) ]} {e}^{( j 2 π {f}_{d} kT )} \\ = K {e}^{( j {f}_{d} )} {e}^{[ - j 2 {π ( {f}_{0} + {f}_{d} / 2 )}_{T} ( t ) ]} {\sum }_{k = 0}^{N - 1} {e}^{\{ - j 2 π k [ Δ {f}_{T} ( t ) - {f}_{d} T ] \}} \\ = K {e}^{( j {f}_{d} )} {e}^{[ - j 4 π / {λ}_{0} R ( t ) ]} {\sum }_{k = 0}^{N - 1} {e}^{\{ - j 2 π / Nk [ N Δ {f}_{T} ( t ) - {Nf}_{d} T ] \}}\end{matrix} \qquad [ 27 ]$$

where k=1 . . . (N−1). For each tone sequence 10 transmitted by radar 1, radar 1 receives as a response signal 15 a vector Rₖ from radar scenario 30, as measured at N discrete frequencies fₖ=f₀+kΔf. Sample values of equation [27] are then elaborated, preferably, by means of the inverse discrete Fourier transform (step 177). This way, radar scenario 31 can be resolved in the range direction, i.e. in a radial direction, in resolution cells 31:

R(k)={Ke^{(jφ}^{_{d}}⁾e^{[-j4π/λ}^{₀}^{R}^{ₜ}^{t)]}}w[n−Rₜ(t)/ΔR−Nf_{d}T], n=0 . . . N−1, [28]

where

$$w [ n ] = 1 / N {\sum }_{k = 0}^{N - 1} {e}^{\{ j 2 π / Nnk \}} \qquad [ 29 ]$$

is 1 if n=0, and 0 in the other cases. Neglecting constant step and amplitude terms:

r(n)=e^{[-j(4π/λ}^{₀}^{)d(t)]}w[n−(R₀/ΔR)−Nf_{d}T], n=0 . . . (N−1) [30]

which differs from the corresponding formula of a SFCW radar system with a natural target, i.e. without transponder 3, by the presence of the term (N f_{d} T) which depends upon the number N tones, by the frequency-shift and by the duration T of each tone. If, for example, R₀=R+mΔR:

r(n)=e^{[-j(4π/λ}^{₀}^{)d(t)]}w[n−m−Nf_{d}T], n=0 . . . (N−1) [31]

and no frequency-shift is carried out (f_{d}=0), the signal portion of the m^{-th} range-bin i.e. of the m^{-th} resolution cell 31 is:

r(m)=e^{[-j(4π/λ}^{₀}^{)d(t)]}, [32]

which allows to calculate the displacement of target 2.

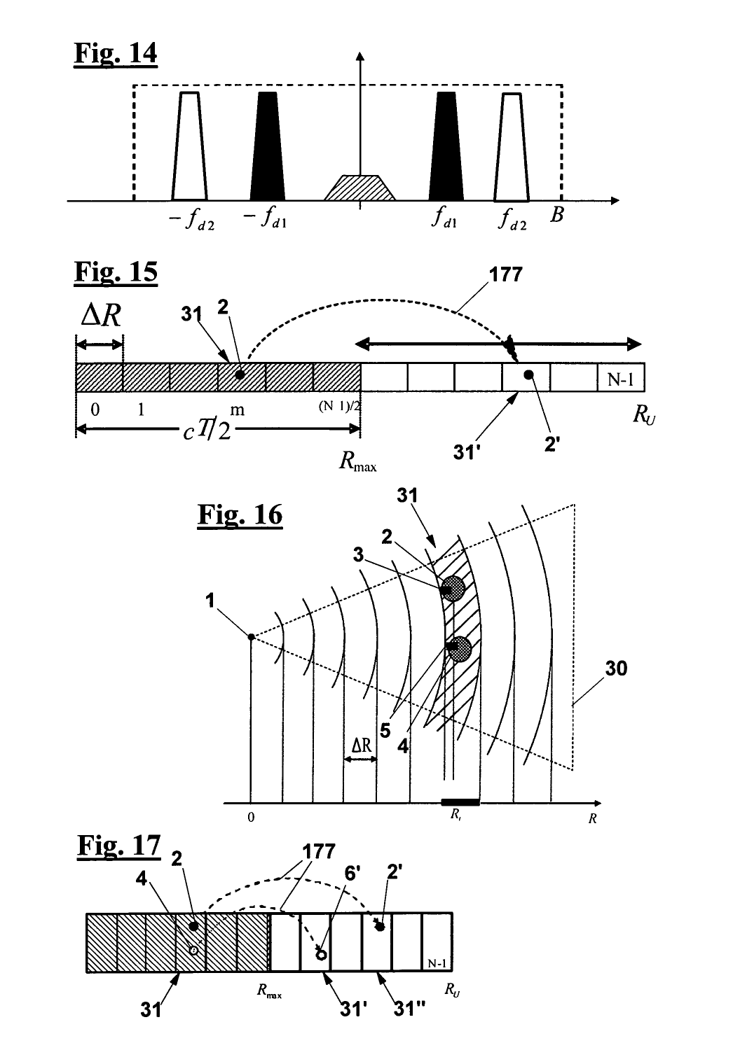

By adding the frequency-shift term −Nf_{d}T a migration is produced of the signal portion that comes from the transponder with respect to the m^{-th} resolution cell, as shown in FIG. 15. The amount of this migration is expressed by the term Nf_{d}T ΔR. In other words, even if the target is located inside the m^{-th} resolution cell 31, by this technique target 2 is displayed in the (m+Nf_{d}T ΔR)^{-th} resolution cell 31′, i.e. the frequency shift, which is associated to inverse discrete Fourier transform 177, produces a virtual range migration of resolution cell 31, and of target 2, from resolution cell 31 into resolution cell 31′.

If parameters T and Δf that defining sequence 10 are chosen as displayed in FIG. 15, i.e. in such a way that:

TΔf=R_{U}/Rₘₐₓ=½ [33]

The half the unambiguous range limit is free from clutter, i.e. it comprises resolution cells 31′ that are free from clutter (FIG. 15). As a matter of fact, the response signal that are received at radar 1 after time T has elapsed, which refer to cells 31′ that are at a distance greater than of Rₘₐₓ from radar 1, undergo a non-coherent demodulation, i.e. they are multiplied by a signal or a signal that is not the same signal that has caused that response signals, but a subsequent tone of the tone sequence emitted by radar 1; therefore, such non-coherently demodulated signals fall outside the radar receiving band. As a consequence, if the transponder is located in a cell 31 that is affected by clutter, a proper choice of frequency-shift f_{d} is needed to cause the target to migrate into one of the range-bin 31′ that are free from clutter.

f_{d}>((N−1)/2−m)/(NTΔR) [34]

The use of a transponder suitable or carrying out a frequency-shift allows therefore to suppress the clutter, which overcomes another drawback of prior art interferometric SFCW radar systems.

If a plurality of targets are present in the in a same resolution cell, a transponder may be provided at each target, which has a frequency shift that is different from the frequency shift of any other transponder, and is selected in such a way that each target migrates in a cell beyond maximum distance observable Rₘ. Migrated cells are therefore distinct from one another. For instance, target 2 and target 4 are present in a same resolution cell 31, as shown in FIGS. 16 and 17. The method provides a step of prearranging a further transponder 5 at target 4; this further transponder executes a further frequency-shifting step with respect to the first and to the second emitted signal 13,16, as received at further target 4, according to a further frequency-shift f_{d2} which is different from frequency-shift f_{d1} of transponder 3 of target 2. This creates further first and second frequency-shifted signals which can be the object of a coherent demodulating step 160, of a sampling step 176 and of inverse discrete Fourier transform application 177; the corresponding migrated sample values may be then be expressed as:

r(n)=e^{[-j(4π/λ0)d(t)]}w[n−m−Nf_{d2}T], n=0 . . . (N−1). [35]

In other words, target 4 migrates into (m+Nf_{d2}T ΔR)^{-th} resolution cell 31″, which is different from (m+Nf_{d1}T ΔR)^{-th} resolution cell 31′ in which target 2 migrates, provided that frequency-shift f_{d1} and further frequency-shift f_{d2} are selected in such a way that the following equations

f_{d1}=p/(NTΔR), [36]

f_{d2}=q/(NTΔR) [37]

are fulfilled, where with p and q are distinct integers, each of them greater than ((N−1)/2−m), in order to fulfil also equation [34]. This way, it is possible to resolve two, and more in general a plurality of targets that are located in a same resolution cell, thus overcoming the prior art methods ambiguity limits.

The demodulated response signal that is sampled at instants T, 2T, 3T . . . (FIG. 14) may be encoded by analogue to digital, in order to digitally carry out inverse discrete Fourier transform application 177, migrated sample value extraction 178, first and second phase computation 179 and displacement computation 180-190.

SFCW radar+SAR/RAR. In this case, a radar scenario 40 (FIG. 12) is subdivided into resolution cells 41 that are smaller than resolution cells 31 of simple SFCW radar (FIG. 11). Resolution cells are defined by two coordinates, i.e. the radial coordinate R, as in the case of simple SFCW radar, and the angular coordinate θ. Since frequency-shifting produce a cell migration only in range, i.e. in a radial direction, while no migration is possible in cross-range, the same considerations can be done in this case as in the case of simple SFCW radar. In other words, due to frequency-shifting, the signal coming from transponder 3 associated with target 2 of cell 41 migrate to a cell 41′ that is located beyond Rₘₐₓ circumference, but has the same angular coordinate of cell 41.

The transponder may be an active transponder, like in the case of devices 70, 80 and 90 (FIGS. 17, 18 and 19); in other words, the transponder may be adapted to amplify the first and the second emitted signals (13,16) as received at the transponder, or the first and the second frequency-shifted signal; this way, the first frequency-shifted signal 14′ and the second frequency-shifted signal 17′ have an amplified amplitude that is greater than the emission amplitude of transmitted signals 13, 16 as received by the transponder. The power received by radar 1 that is associated with the signal coming from a transponder that is located at a distance Rₜ from the radar can be written:

$${P}_{r} = \frac{{λ}^{2}}{4 π} \frac{{P}_{t} {G}^{2}}{{( 4 π \cdot {R}_{t}^{2} )}^{2}} \cdot ( \frac{{λ}^{2}}{4 π} {G}_{a}^{2} \cdot {G}_{A} ) \qquad [ 38 ]$$

where G, G_{A} and Gₐ are respectively the gain values of antennas 11 and 12 of radar 1, of the amplifier and of transponder 3, and λ is the wavelength of the emitted signal. The power received by a target that is located at the same distance is:

$${P}_{r} ≅ \frac{{λ}^{2}}{4 π} \frac{{P}_{t} {G}^{2}}{{( 4 π \cdot {R}_{t}^{2} )}^{2}} \cdot {σ}_{t} \qquad [ 39 ]$$

where, σₜ is the Radar Cross Section of the target, which is a parameter that depends mainly upon target effective area target material reflectivity, and resumes the reflection features of a target with respect to a radar signal; in other words, σₜ expresses how the target is detectable by a radar device. Therefore, if:

(λ²/4π)Gₐ²G_{A}>σₜ [40]

the power that is received by a transponder at a distance Rₜ is higher than the one that can be received by the natural target at the same distance, i.e. by the target itself, without transponder; the higher the power received, the higher the signal-to-noise ratio is and, therefore, the better the displacement measuring accuracy is. In other words, if an active transponder is used that is suitably designed according to eq. [40], allows a better displacement measuring accuracy, with respect to the accuracy that can be offered by a natural target, at the same distance Rₜ; conversely, if such a suitably designed active transponder is used, the displacement of a target can be detected at a higher distance, with a given measuring accuracy.

Of course, the same advantages would be possible, even if no frequency-shifting were carried out at the target, i.e. even if a simple amplifier were provided at the target instead of a transponder.

Therefore, the method according to the invention allows to measure a target displacement with a precision that is substantially independent from the distance between the radar and the target, however the radar is selected among the above-mentioned interferometric radar.

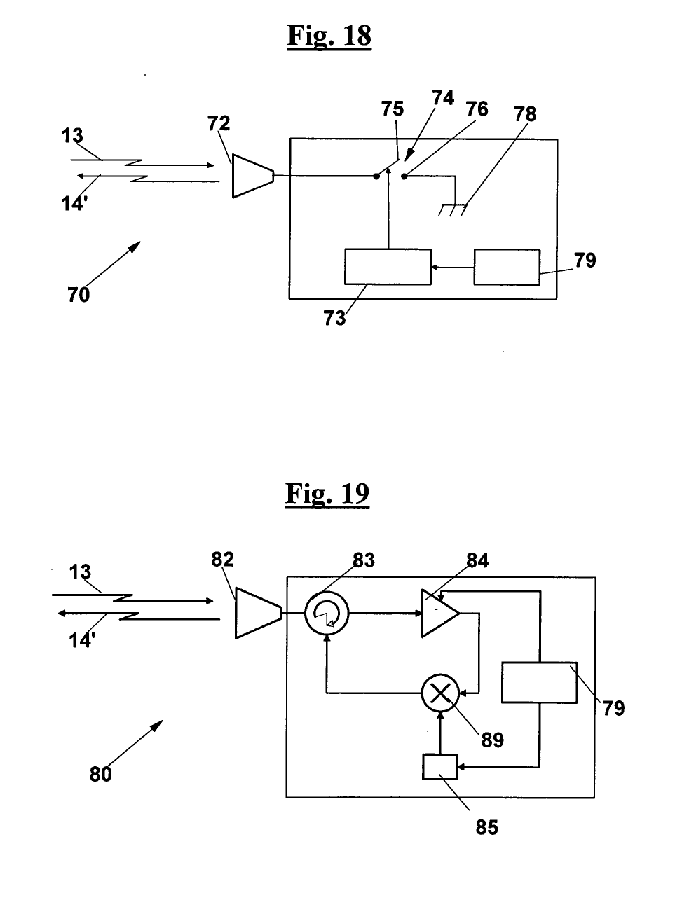

FIG. 18 diagrammatically shows a first transponder 70 that is adapted to carry out the method according to the invention. Transponder 70 consists of:

an antenna 72 that is used both for receiving emitted signal 13 from an interferometric radar, and for transmitting frequency-shifted signal 14′ towards this radar;

a switch 74 that switches between an open circuit position 75 in which it reflects emitted signal 13 as received by antenna 72, and a short-circuit position 76 where emitted signal 13 as received by antenna 72 is brought to ground 78; in such a way a frequency shifted signal 14′ is created and retransmitted trough the antenna 72

a square-wave signal generator 73 for controlling a switch 74, which produce a square wave which has a frequency equal to frequency-shift f_{d};

an electric power supply device 79 to provide power supply to a transponder 70, for example a battery.

Actually, switch 74 carries out modulates the received signal by shifting its frequency from f₀ to f₀+f_{d} to f₀−f_{d}.

FIG. 19 shows diagrammatically a second transponder 80 that may be used for carrying out the method according to the invention. Transponder 80 comprises:

an antenna 82 that is used both for receiving emitted signal 13 from an interferometric radar, and for transmitting frequency-shifted signal 14′ towards this radar;

an amplifier 84 that amplifies the signal received by antenna 82;

a local oscillator 85 that generates a sinusoid which has a frequency f_{d} that is equal to frequency shift;

a mixer 89 that cause the multiplication between the sinusoid and the radar signal received by antenna 82 and amplified by amplifier 84, the frequency shift generating a frequency-shifted signal that has a frequency f₀+f_{d};

a circulator 83 that allows the use of the one antenna 82 both for transmitting and for receiving. The circulator must to be properly sized to prevent frequency-shifted signal, when received at transponder 80, from causing signal oscillations;

an electric power supply device 79 to provide power supply to a transponder 70, for example a battery.

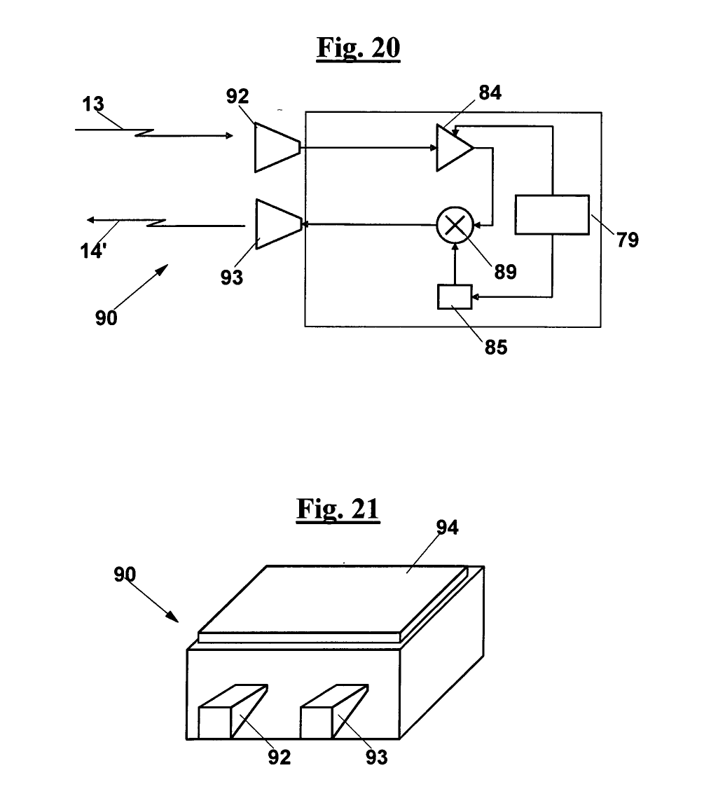

In alternative, a third type of transponder is diagrammatically shown in FIG. 20, which has a transmitting antenna 92 and a receiving antenna 93, therefore circulator 83 is not necessary. No coupling is provided between transmitting and receiving circuits which limits the risks of causing self-oscillations.

Furthermore, as shown in FIG. 21, the apparatus may comprise one or more solar cells 94 for recharging battery 79.

Transponders 70, 80, 90 may be built using low cost and easily available components.

As described, also passive transponders, i.e. a plurality of transponder in which no signal amplification means is provided, allow to resolve a plurality of targets in the same radar scenario or in the same resolution cell, and also allow to suppress the clutter.

Advantageously, transponder 70 or 80 or 90 may be provided with a WIFI receiver that has its own antenna, and with a microcontroller that is adapted to receive and decode IP messages which come from a remote control station. This is useful, for instance, to set one or more transponder operating parameter in particular to set the frequency shift, or to switch on/off an active transponder. In particular, the frequency shift may be set by changing the frequency f_{d} of the square wave signal that is generated by the square wave signal generator of signal of transponder 70, or by changing the frequency of the sinusoid that is generated by local oscillator 85 of transponders 80 or 90, which may be carried out by suitably adjusting oscillator internal circuit resistance.

The foregoing description of specific embodiments will so fully reveal the invention according to the conceptual point of view, so that others, by applying current knowledge, will be able to modify and/or adapt for various applications such embodiments without further research and without parting from the invention, and it is therefore to be understood that such adaptations and modifications will have to be considered as equivalent to the specific embodiments. The means and the materials to realise the different functions described herein could have a different nature without, for this reason, departing from the field of the invention. It is to be understood that the phraseology or terminology employed herein is for the purpose of description and not of limitation.

1. A method for estimating a displacement of a remote object in a radar scenario by means of an interferometric radar, said method comprising the steps of:
transmitting from said radar a first emitted signal at a first instant and a second emitted signal at a second instant, said first emitted signal and said second emitted signal having an emission frequency and an emission amplitude;
receiving at said remote object said first emitted signal and said second emitted signal;
receiving at said radar a first response signal and a second response signal from said radar scenario, said first response signal and said second response signal comprising respectively a first remote object response signal portion and a second remote object response signal portion;
demodulating said first response signal and said second response signal, said step of demodulating creating a first demodulated response signal and a second demodulated response signal comprising respectively a first demodulated frequency-shifted signal and a second demodulated frequency-shifted signal;
extracting a first phase and a second phase respectively from said first demodulated frequency-shifted signal and from said second demodulated frequency-shifted signal;
computing a difference between said first phase and said second phase;
computing a displacement of said remote object, said displacement responsive to said difference between said first phase and said second phase,
characterized in that said method comprises furthermore the steps of:
prearranging a transponder at said remote object;
frequency-shifting, at said transponder, said first emitted signal and said second emitted signal as received at said remote object, said frequency-shifting step creating a first frequency-shifted signal and a second frequency-shifted signal that have a shifted frequency that differs from said emission frequency by a predetermined frequency-shift, and retransmitting from said transponder said first frequency-shifted signal and said second frequency-shifted signal, such that said first remote object response signal portion and said second remote object response signal portion respectively comprise said first frequency-shifted signal and said second frequency-shifted signal,
such that said first and said second demodulated frequency-shifted signal have a frequency that differs from said emission frequency responsive to said frequency shift.

2. The method according to claim 1, wherein said frequency shift is selected such that the wavelength of said first and said second emitted signal differs from said the wavelength of said first and said second frequency-shifted signals less than a predetermined frequency shift f_{d}, in order to univocally establish said displacement of said remote object with respect to said difference between said first phase and said second phase.

3. The method according to claim 2, wherein said predetermined frequency-shift f, is at least six orders of magnitude (10⁻⁶) lower than said emitted frequency.

4. The method according to claim 1, wherein said step of demodulating is a coherent demodulation that provides multiplying said first response signal and said second response signal respectively by said first emitted signal and by said second emitted signal.

5. The method according to claim 1, wherein said phase-extracting step comprises:
multiplying said first demodulated response signal and said second demodulated response signal by a phasor, said phasor being a periodic signal having a frequency equal to said frequency-shift, said multiplying step creating a first baseband signal and a second baseband signal which respectively comprise a first baseband demodulated frequency-shifted signal and a second baseband demodulated frequency-shifted signal;
filtering said first baseband signal and said second baseband signal, said filtering step suppressing portions of signals whose frequency is in absolute value greater than an unilateral filter bandwidth, said filtering step producing a first baseband filtered signal and a second baseband filtered signal;
computing said first phase and said second phase respectively from said first baseband filtered signal and from said second baseband filtered signal, wherein said predetermined frequency-shift is greater than said unilateral filter bandwidth.

6. The method according to claim 1, wherein a further remote object is present in said radar scenario, and said method provides the steps of:
prearranging a further transponder at said further remote object;
further frequency-shifting, in said transponder, said first emitted signal and said second emitted signal as received at said further remote object, said further frequency-shifting step creating a further first frequency-shifted signal and a further second frequency-shifted signal that have a further shifted frequency that differs from said emission frequency by a further predetermined frequency-shift, and retransmitting from said further transponder said further first frequency-shifted signal and said further second frequency-shifted signal;
further phase-extracting, said further phase-extracting step extracting a further first phase and a further second phase respectively of said further first demodulated frequency-shifted signal and of said further second demodulated frequency-shifted signal;
computing a difference between said further first phase and said further second phase;
computing a displacement of said further remote object, said displacement responsive to said difference between said further first phase and said further second phase.

7. The method according to claim 1, wherein said first emitted signal and said second emitted signal comprise a repeated sequence of tones that have:
a predetermined duration of said tones, such that a tone reflected by a remote object that is located at a predetermined distance from said radar is received at said radar before that said radar stops transmitting said tone, such that a coherent demodulation of said tone is carried out at said radar, said predetermined distance being called the maximum radar range of said radar;
respective different frequencies, said frequencies differing by a predetermined frequency pitch, such that an unambiguous range limit is defined, i.e. a distance is defined that is related to said frequency pitch, and within which the displacement of a remote object may be established without ambiguity by said radar;
such that said radar scenario set between said radar and said unambiguous range limit is subdivided in a plurality of resolution cells that are equal in number to said tones of said sequence of tones, and said radar measures a displacement of said remote object in a predetermined cell selected among said plurality of resolution cells, said predetermined cell called an observed resolution cell,
wherein said frequency pitch is set such that said unambiguous range limit is greater than said maximum radar range,
wherein said step of extracting comprises the steps of:
acquiring a first sequence of sample values of said first demodulated response signal and a second sequence of sample values of said second demodulated response signal, each sample value of said first sequence and each sample value of said second sequence corresponding to a tone of said sequence of tones, each of said sample values comprising a signal portion related to a respective demodulated frequency-shifted signal;
applying an inverse discrete Fourier transform (IDFT) to said first sequence of sample values and to said second sequence of sample values, such that a first transformed sequence of sample values of said first demodulated response signal and a second transformed sequence of sample values of said first demodulated response signal are obtained, each sample value of said first transformed sequence and each sample value of said second transformed sequence associated to one resolution cell,
wherein said signal portion relative to a respective demodulated frequency-shifted signal is migrated from said observed resolution cell into one of said migrated resolution cells responsive to the value of said frequency shift;
extracting from said first transformed sequence and from said second transformed sequence a first sample value and a second sample value which are associated to said migrated resolution cell;
computing said first phase and said second phase of respective sample values which are associated to said migrated resolution cell.

8. A method according to claim 7, wherein said predetermined frequency pitch is a positive pitch.

9. A method according to claim 7, wherein said frequency pitch is set such that said unambiguous range limit is substantially double of said maximum radar range, and said resolution cells, whose diameter is less or equal to said maximum radar range, are equal in number to said resolution cells, which are called displaced resolution cells, that have a diameter set between said maximum radar range and said unambiguous range limit,

10. The method according to claim 6, wherein said remote object and said further remote object are located in said observed resolution cell, and said further frequency-shift is set such that said signal portion which is associated to a respective further demodulated frequency-shifted signal is migrated from said observed resolution cell into a further migrated resolution cell that is different from said migrated resolution cell.

11. The method according to claim 1, comprising the steps of:
prearranging an amplifier at said remote object;
amplifying, at said amplifier, said first and said second emitted signal as received at said transponder, or said first and said second frequency-shifted signal, such that said first frequency-shifted signal and said second frequency-shifted signal have an amplified amplitude that is greater than said emission amplitude.

12. The method according to claim 1, wherein said method provides a step of fixing said frequency-shift and/or said further frequency-shift from a remote position, in particular by means of wireless communication techniques, in particular by means of WIFI communication techniques.

13. A method for estimating a displacement of a remote object in a radar scenario using a transponder, by means of an interferometric radar,
wherein said transponder is prearranged at said remote object;
and wherein said transponder is associated with a radar system that operates with the method according to any of the previous claims.

14. The method according to claim 13, wherein said object is a ground-based object selected from the group consisting of:
landslides,
subsidence and bradyseism,
civil works such as buildings, bridges, off-shore structures,
river banks, and
open pits.
